(19) United States
(12) Patent Application Publication
(10) Pub. No.: US 2012/0301156 A1
(43) Pub. Date: Nov. 29, 2012

(54) OPTICAL TRANSMITTER SUBASSEMBLY

(75) Inventors: Lance THOMPSON, San Jose, CA (US); Phillip EDWARDS, San Jose, CA (US); Jignesh SHAH, San Jose, CA (US)

(73) Assignee: SUMITOMO ELECTRIC INDUSTRIES, LTD., Osaka-shi (JP)

(21) Appl. No.: 13/324,852

(22) Filed: Dec. 13, 2011

Related U.S. Application Data
(63) Continuation-in-part of application No. 13/114,636, filed on May 24, 2011.

(51) Int. Cl. H04B 10/04

(52) U.S. Cl. 398/188

(57) ABSTRACT

An optical transmitter subassembly of one embodiment includes a temperature controller, first to third bases, a laser diode, and an optical system. The temperature controller includes first and second plates, and temperature controlling elements put between the first and second plates. The first base has first and second regions, and is supported by the first plate. The second base is mounted on the first region. The third base is mounted on the second region. The laser diode is a tunable laser diode integrated with a Mach-Zehnder type optical modulator, and is mounted on the second base. The optical system is capable of fixing a wavelength of the laser diode and is mounted on the third base. Only a portion of the first base is mounted on the first plate. The portion of the first base includes the first region.

### RELATED APPLICATIONS

This application is a continuation-in-part application of and claims a benefit of priority from U.S. patent application Ser. No. 13/114,636, filed on May 24, 2011, the entire contents of which are incorporated herein by reference.

### BACKGROUND

1. Field

Embodiments of the present invention relate to an optical transmitter subassembly.

2. Related Background

The Wavelength Division Multiplexing (WDM) optical communication system has been practical. One standard of the dense WDM (DWDM) communication system, which is one of the WDM standard, rules 100 grid wavelengths with a span of 50 GHz in the 1550 nm range (i.e. a frequency range of 192 THz-197 THz).

In the meantime, optical transmitter modules that control a temperature of a laser diode are described in U.S. Pat. No. 6,801,553 and U.S. Pat. No. 7,038,866.

### SUMMARY

An optical transmitter subassembly utilized in the WDM communication system is required to install a temperature controller for controlling a temperature of a laser diode to control a wavelength. The temperature controller generally includes a plurality of Peltier elements.

In the field, it is required that a cost of such an optical transmitter subassembly is reduced.

One aspect of the present invention relates to an optical transmitter subassembly. The optical transmitter subassembly of the aspect includes a temperature controller, first to third bases, a laser diode, and an optical system. The temperature controller includes first and second plates, and temperature controlling elements put between the first and second plates. The first base has first and second regions, and is supported by the first plate. The second base is mounted on the first region of the first base. The third base is mounted on the second region of the first base. The laser diode is a tunable laser diode integrated with a Mach-Zehnder type optical modulator, and is mounted on the second base. The optical system is capable of fixing a wavelength of the laser diode and is mounted on the third base. Only a portion of the first base is mounted on the first plate. The portion of the first base includes the first region.

In the optical transmitter subassembly, the first region of the first base is mounted on the first plate of the temperature controller. Since the laser diode is mounted above the temperature controller, the temperature of the laser diode which is necessary to be controlled more precisely than that of the optical system may be controlled precisely. In addition, only a portion of the first base is mounted on the first plate, which may reduce a plane area of a region where the temperature controller is arranged. As a result, the number of temperature controlling elements may be reduced. Accordingly, the cost of the optical transmitter subassembly may be reduced.

In one embodiment, the first plate may extend beyond a boundary between the first region and the second region and extend to an intermediate portion of the second region in a direction from the first region toward the second region. According to the embodiment, a resonant frequency of the other portion of the first base, or a free portion of the base that is not supported by the first plate may be raised. The optical system is mounted above the other portion. Therefore, the embodiment may allow vibration amplitude of the optical system caused by mechanical shock to be reduced.

In one embodiment, the first base may have an edge that terminates the second region in the direction, the first and second plates may have edges that terminate the first and second plates in the direction, respectively, and a distance between the edge of the first base and the edge of the second plate in the direction may be larger than a distance between the edge of the first base and the edge of the first plate in the direction. The embodiment may reduce the aforementioned plane area.

In one embodiment, the optical system may include: a first coupler that divides light from the laser diode to output at lease first light and second light; a second coupler that divides the first light to output at least third light and fourth light; a first photodiode that receives the third light; an etalon filter that has periodic transmittance with respect to a wavelength and transmits a portion of the second light therethrough; and a second photodiode that receives light transmitted through the etalon filter. The embodiments may utilize a light intensity sensed by the second photodiode to control a wavelength of the laser diode.

In one embodiment, a thickness of the second base may be larger than a thickness of the third base. The embodiment may allow the resonant frequency of the third base to be raised. Accordingly, the vibration amplitude of the optical system caused by mechanical shock may be reduced.

In one embodiment, the second and third bases may be made of AlN. In one embodiment, the first plate may be made of sapphire or AlN. In one embodiment, the first base may be made of CuW.

### BRIEF DESCRIPTION OF THE DRAWINGS

The foregoing and other purposes, aspects and advantages will be better understood from the following detailed description of embodiments with reference to the drawings, in which:

FIG. 1 is a perspective view illustrating an outer appearance of an optical transceiver according to one embodiment;

FIG. 2 is a perspective view illustrating an inside of the optical transceiver according to one embodiment;

FIG. 3A and FIG. 3B schematically illustrate a laser region according to one embodiment;

FIG. 4A and FIG. 4B are diagrams for explaining a wavelength characteristic of a SG-DFB region according to one embodiment;

FIG. 5A and FIG. 5B are diagrams for explaining one example of a reflectance spectrum of a CSG-DBR region according to one embodiment;

FIG. 6A and FIG. 6B are diagrams for explaining another example of a reflectance spectrum of a CSG-DBR region according to one embodiment;

FIG. 7A and FIG. 7B are diagrams for explaining still another example of a reflectance spectrum of a CSG-DBR region according to one embodiment;

FIG. 8 is a plan view schematically illustrating an optical modulator region according to one embodiment;

FIG. 9 is a perspective view illustrating an inside of an optical transmitter subassembly according to one embodiment; and

FIG. 10 is a side view illustrating an inside of a case of an optical transmitter subassembly according to one embodiment.

### DETAILED DESCRIPTION

Next, various embodiments will be described with reference to the accompanying drawings. In the description of the drawings, the same numeral or symbol will refer to the same element without overlapping explanations.

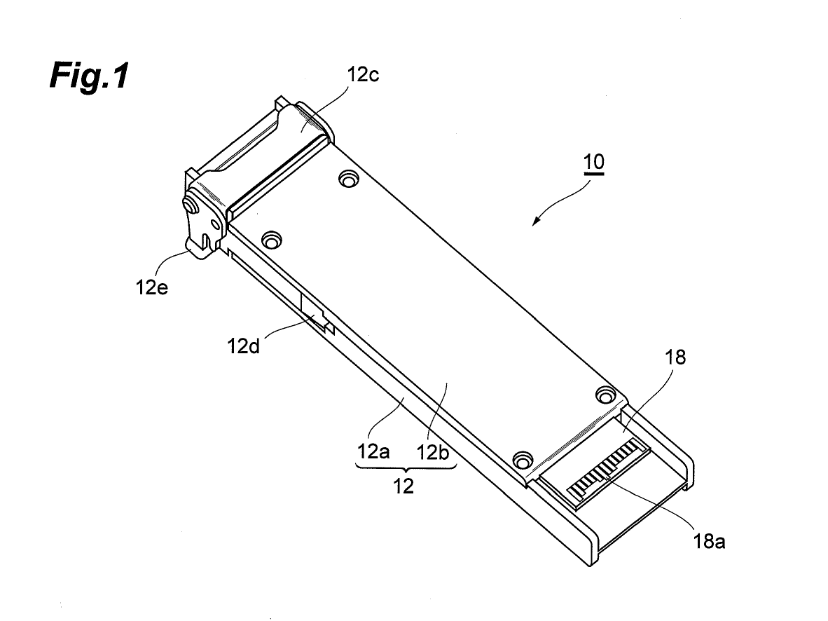

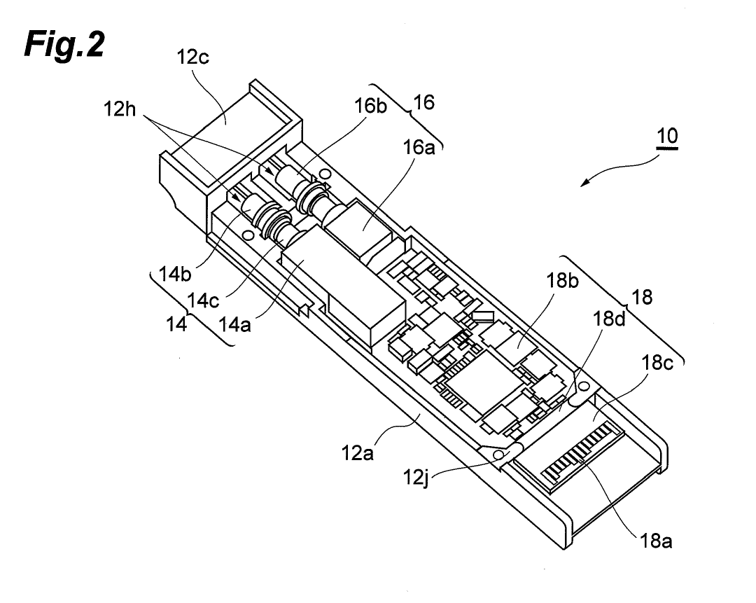

FIG. 1 illustrates an outer appearance of an optical transceiver according to one embodiment. FIG. 2 illustrates an inside of an optical transceiver according to one embodiment. An optical transceiver 10 shown in FIG. 1 and FIG. 2 includes a housing 12 substantially made of a metal. In one embodiment, the housing 12 includes a first housing 12a and a second housing 12b, and has a structure that is separable into up and down. FIG. 2 illustrates the optical transceiver 10 in a state where the second housing 12b is omitted.

The housing 12 may comply with XFP (i.e. 10 Gigabit Small Form Factor Pluggable) standard. Installed in the inside of the housing 12 are an optical transmitter subassembly (hereinafter referred as “TOSA”) 14, an optical receiver subassembly (hereinafter referred as “ROSA”) 16, and a circuit board 18 mounting therein electronic circuits electrically connected with the OSAs.

The housing 12 has an optical receptacle 12c at the front side thereof. The optical receptacle 12c may engage with an external optical connector. Inserting the external optical connector into the optical receptacle and then inserting ferrules attached to tip ends of optical fibers of the external optical connector into sleeves of OSAs placed in the optical receptacle 12c, the optical fibers may be optically coupled with optical devices (i.e. a laser diode and a photodiode) that are provided in the OSAs.

The housing 12 has a latch mechanism 12d. The latch mechanism 12d has a function that it engages with a cage prepared in a host system, and securely latches the optical transceiver 10 with the cage. The sides of the optical receptacle 12c support a bail 12e formed substantially U-shape. Rotating the bail 12e so as to traverse the front of the optical receptacle 12c, the engagement between the latch mechanism 12d and the cage can be released. On the other hand, when the optical receptacle 12c engages with the external optical connector, the bail 12e can not be rotated, and the optical transceiver 10 can not be removed from the cage.

At the back side of the optical transceiver 10, a rear end of the mother board 18 is exposed to the outside of the housing 12. The rear end of the mother board 18 has an electrical plug 18a. The electrical plug 18a configures an interface for the optical transceiver 10 to electrically communicate with the host system.

The electrical plug 18a has a plurality of electrodes. The electrodes include an electrode for a power supply, an electrode for a ground, and signal electrodes. Lengths of the electrodes for the power supply and the ground are different from lengths of the signal electrodes so that, when the electrical plug 18a is inserted into the electrical connector of the host system, the electrodes for the power supply and the ground first establish the connection, and then the signal electrodes establish the connection. Thus, in the optical transceiver 10, the power supply is first provided from the host system and stabilized, and then the signal transmission may be performed under a stabilized condition, which may save procedures to turn off the power of the host system at the mating of the electrical plug 18a with the electrical connector.

An optical transceiver providing such mechanism to latch it to the host system is generally called as “pluggable transceiver”. In addition, an optical transceiver further providing a function to activate it without shutting the power of the host system off is called as “hot-pluggable transceiver”.

Referring to FIG. 2, in the optical transceiver 10, the TOSA 14 and the ROSA 16 have rectangular bodies 14a and 16a, respectively. Namely, the TOSA 14 and the ROSA 16 are called as a butterfly module. The TOSA 14 and the ROSA 16 have cylindrical sleeves 14b and 16b, respectively. The sleeves 14b and 16b extend forward from front walls of the bodies 14a and 16a, respectively. The sleeves 14b and 16b are inserted into cavities 12h defined by the optical receptacle 12c. The sleeves 14b and 16b may receive in the cavities 12h the ferrules of the external optical connecter.

The circuit board 18 includes a primary area 18b, an exposed area 18c including the rear end in which the electrical plug 18a is formed, and a necked portion 18d. The necked portion 18d is provided between the primary area 18b and the exposed area 18c, and has a width narrower than those of the primary area 18b and exposed area 18c.

The housing 12 defines a space in which the primary area 18b is placed. The housing 12 includes a rear wall 12j that defines the space from the rear side. The rear wall 12j defines a path that is narrower than a width of the space, and the path connecting the space and the outside of the housing 12. The necked portion 18d is set in the path. Thus, the rear wall 12j may prevent forward and back movement of the circuit board 18 and may absorb a stress caused by insertion/extraction of the electrical plug 18a with the electrical connector so that the stress does not affect the OSAs 14 and 16. It should be noted that, in explanations herein, the terms describing directions, that is, “front”, “back” and the likes are used for sake of the explanation, and a direction in which the electrical plug 18a exists with respect to the optical receptacle 12c is referred as “rear” or “back”, and the opposite direction is referred as “front” or “forth”.

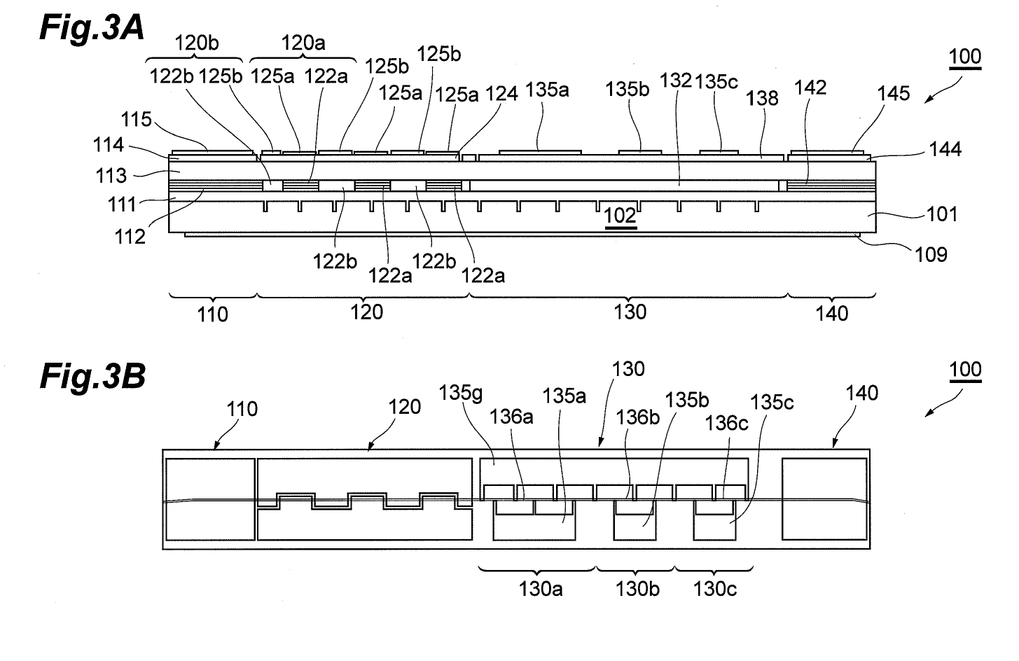

The TOSA 14 of one embodiment has a tunable laser diode (hereinafter referred as “LD”) 20 in a body 14a. The structure and operation of the LD 20 will be described. In one embodiment, the LD 20 is a tunable laser diode integrated with a Mach-Zehnder type optical modulator, and has a laser region 100 and an optical modulator region 200. FIG. 3A illustrates a cross section of the laser region 110, and FIG. 3B illustrates a top view of the laser region 100.

As shown in FIGS. 3A and 3B, the laser region 100 includes a semiconductor optical amplifier (hereinafter referred as “SOA”) region 110, a sampled grating distributed feedback (hereinafter referred as “SG-DFB”) region 120, a chirped sampled grating distributed Bragg reflector (hereinafter referred as “CSG-DBR”) region 130, and an optical absorber region 140, and has a structure in which those regions are arranged in series. The SOA region 110 includes has a structure in which a lower cladding layer 111, an amplifying/absorbing layer 112, an upper cladding layer 113, a contact layer 114, and an electrode 115 are stacked on a substrate 101 in this order.

The SG-DFB region 120 has a structure in which the lower cladding layer 111, a layer including active layers 122a and optical guiding layers 122b, the upper cladding layer 113, another contact layer 124, and an electrode layer including DFB electrodes 125a and tuning electrodes 125b are stacked on the substrate 101 in this order. The active layers 122a and the optical guiding layers 122b are alternatively arranged along an optical guiding direction. In addition, the DFB electrodes 125a and the tuning electrodes 125b are alternatively arranged along the optical guiding direction. The SG-DFB region 120 includes DFB regions 120a and tuning regions 120b which are alternatively arranged along the optical guiding direction. Each of the DFB regions 120a includes the active layer 122a and the DFB electrode 125a, and each of the tuning regions 120b includes the optical guiding layer 122b and the tuning electrode 125b. In one embodiment, three segments, each of which is configured with one DFB region 120a and one tuning region 120b, are arranged in the optical guiding direction.

The CSG-DBR region 130 has a structure in which the lower cladding layer 111, an optical guiding layer 132, the upper cladding layer 113, an insulating film 138, and an electrode layer including a plurality of heater electrodes 135a, 135b, 135c and a ground electrode 135g are stacked on the substrate 101 in this order. In the CSG-DBR region 130, a plurality of heaters are formed.

In one embodiment, the heater electrode 135a has three fingers that extend from a common base portion in a direction crossing with the optical guiding direction. Each of the heater electrodes 135b and 135c has two fingers that extend from a common base portion in the direction crossing with the optical guiding direction. The ground electrode 135g has nine fingers that extend from a common base portion in the direction crossing with the optical guiding direction. The fingers of the heater electrodes 135a, 135b, and 135c and the fingers of the ground electrode 135g are alternatively arranged in the optical guiding direction. Formed between the fingers of the heater electrode 135a and the fingers of the ground electrode 135g are six of first heaters 136a that are configured with thin-film resistors. Similarly, formed between the fingers of the heater electrode 135b and the fingers of the ground electrode 135g are four of second heaters 136b that are configured with thin-film resistors, and formed between the fingers of the heater electrode 135c and the fingers of the ground electrode 135g are four of third heaters 136c that are configured with thin-film resistors,

As shown in FIG. 3A, the OA region 140 has a structure in which the lower cladding layer 111, an optical absorption layer 142, the upper cladding layer 113, another contact layer 144 and an electrode 145 are stacked on the substrate 101 in this order. The SOA region 110, the SG-DFB region 120, the CSG-DBR region 130, and the OA region 140 share the substrate 101, the lower cladding layer 111, and the upper cladding layer 113 with each other. In addition, the optical amplifying/absorbing layer 112, the active layers 122a, the optical guiding layers 122b, the optical guiding layer 132, and the absorption layer 142 are formed along the same plane. The substrate 101 provides a back-surface electrode 109 on a back surface thereof. The back-surface electrode 109 is formed across the regions 110, 120, 130, and 140.

As shown in FIG. 3A, a plurality of diffraction gratings (i.e. corrugations) 102 are formed in the lower cladding layer 111 of the SG-DFB region 120 and the CSG-DBR region 130. The diffraction gratings 102 are spaced apart from each other in the optical guiding direction. The SG-DFB region 120 and the CSG-DBR region 130 have a plurality of segments. Each of the segments includes a set of a region where the diffraction grating 102 is formed and an adjacent space where the diffraction grating 102 is not formed. In one embodiment, the SG-DFB region 120 includes five segments and the CSG-DBR region 130 includes seven segments. The diffraction gratings 102 are made of material different from that of the lower cladding layer 111. In one embodiment, if the lower cladding layer is made of InP, the diffraction gratings 102 may be made of In_{0.78}Ga_{0.22}As_{0.47}P_{0.53}.

In the CSG-DBR region 130, optical lengths at least two segments are different from each other, which provides a plurality of peaks of the wavelength characteristic of the CSG-DBR region 130 with wavelength dependency. On the other hand, in the SG-DFB region 120, optical lengths of the segments are substantially equal to each other. In the laser region 100, the Vernier Effect created by a combination of the SG-DFB region 120 and CSG-DBR region 130 is utilized to realize stable laser emission at a desired wavelength.

In one embodiment, the common substrate 101 may be an InP semiconductor substrate. The optical guiding layer 132 may be made of InGaAsP whose fundamental absorption edge corresponds to a wavelength shorter than the wavelength of the laser emission. For instance, the optical guiding layer 132 may have a bandgap wavelength of about 1.3 μm. The active layers 122a may be made of InGaAsP with an optical gain for a target emission wavelength. For instance, the active layers 122a may have the bandgap wavelength of about 1.57 μm. The optical amplifying/absorbing layer 112 may be made of InGaAsP to control the magnitude of the emission by amplifying, or sometimes absorbing the light. For instance, the optical amplifying/absorbing layer 112 may have the bandgap wavelength of about 1.57 μm. The amplifying layer 112 and the absorbing layer 142 may be made of material having absorbing characteristic to the emission wavelength of the laser region 100. The active layers 122a, the amplifying/absorbing layer 112 and the absorbing layer 142 may have the quantum well structure, where well layers made of Ga_{0.47}In_{0.53}As with a thickness of nm and barrier layers made of Ga_{0.28}In_{0.72}As_{0.61}P_{0.39} with a thickness of 10 nm are alternately stacked. The amplifying/absorbing layer 112 and the absorbing layer 142 may have the bulk configuration made of Ga_{0.46}In_{0.54}As_{0.98}P_{0.02}. These layers 112 and 142 may be made of material same as that of the active layers 122a. In such a combination, the manufacturing process may be simplified because the active layers 122a, the amplifying/absorbing layer 112, and the absorbing layer 142 are formed at a time.

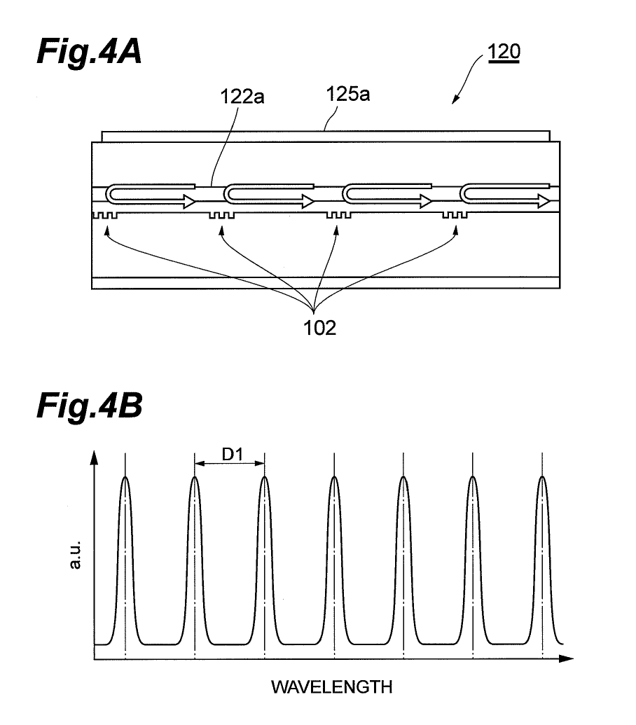

Next, a method to select the emission wavelength of the laser region 100 will be described. FIG. 4A and FIG. 4B are diagrams for explaining a wavelength characteristic of a SG-DFB region according to one embodiment. In FIG. 4A, a SG-DFB region of one embodiment is illustrated without tuning electrodes. In FIG. 4B, an emission spectrum of the SG-DFB region is illustrated. Here, we assume a structure where the tuning electrodes 125b are omitted. Injecting a preset driving current into the DFB electrode 125a, the active layers 122s may generate photons. Since the SG-DFB region 120 provides the sampled gratings 102, the wavelength characteristic of the SG-DFB region alone includes a plurality of peaks, as shown in FIG. 4B. The interval DI of the plurality of peaks is determined the following mathematical expression (1).

DI∝I²/n_{eg}/L_{SG} (1)

In the expression (1), “I” is an amount of current injected from the DFB electrode 125a, “n_{eq}” is an equivalent refractive index of the segment, and “L_{SG}” is a length of the segment. Injecting a current from the DFB electrode 125a into the active layers 122a, the carrier distribution in the active layers 122a is modulated, which changes the peak interval.

In addition, the CSG-DBR region 130 provides the plurality of segments, each of which includes the sampled grating 102 and the adjacent space. A reflection spectrum of the CSG-DBR region 130 has a plurality of peaks. The wavelength interval between the peaks of the reflection spectrum of the CSG-DBR region 130 is slightly different from the wavelength interval of the peaks of the emission spectrum of the SG-DFB region 120. Therefore, in the structure where the SG-DBR region 120 and the CSG-DBR region 130 are integrated with each other, the laser emission may occur at the wavelength where the peaks of these regions coincide with each other. This is called as “Vernier Effect”.

In a case where the SG-DBR regions 120 is integrated with the CSG-DBR 130 region having a plurality of segments whose lengths are eqaul to each other, the peaks of the regions 120 and 130 coincide with each other at wavelengths corresponding to the integral multiple of the least common multiple between the wavelength interval of the emission spectrum of the SG-DFB region 120 and the wavelength interval of the reflection spectrum of the CSG-DBR region 130. Therefore, the emission wavelength of the laser region is not uniquely determined. To address this issue, in the laser region 100 of one embodiment, optical lengths of segments of at least one region among a plurality of regions in the CSG-DBR region 130 are different from the optical lengths of the segments of the other regions. Such a structure is called as “Chirped Sampled Grating Distributed Bragg Reflector” (i.e. CSG-DBR).

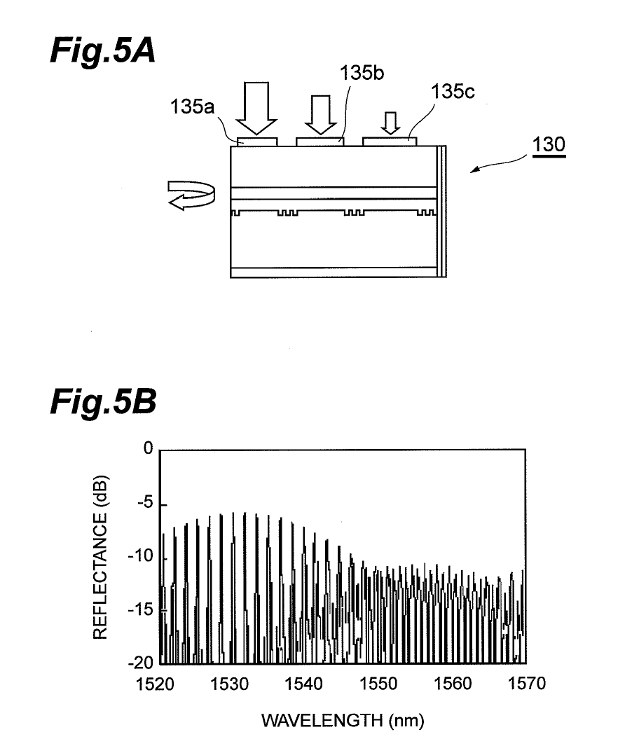

In one embodiment, the CSG-DBR region 130 include regions 130a, 130b, and 130c, in this order in the optical guiding direction. The optical lengths of the segments included in the region 130a are shorter than the optical lengths of the segments included in the region 130b, and the optical lengths of the segments included in the region 130b are shorter than the optical lengths of the segments included in the region 130c. The temperatures of the region 130a, 130b, 130c may be controlled with the heaters 136a, 136b, 136c, respectively. Here, FIGS. 5A, 5B, 6A, 6B, 7A, and 7B are referred. These figures are diagrams for explaining examples of a reflection spectrum of a CSG-DBR region. FIGS. 5A, 6A and 7A illustrate CSG-DBR region of one embodiment. The size of the arrow depicted in FIGS. 5A, 6A and 7A corresponds to an amount of current supplied to the heater electrode. FIGS. 5B, 6B, and 7B illustrate reflection spectra in cases where the currents are supplied to the heater electrodes as shown in FIGS. 5A, 6A and 7A, respectively.

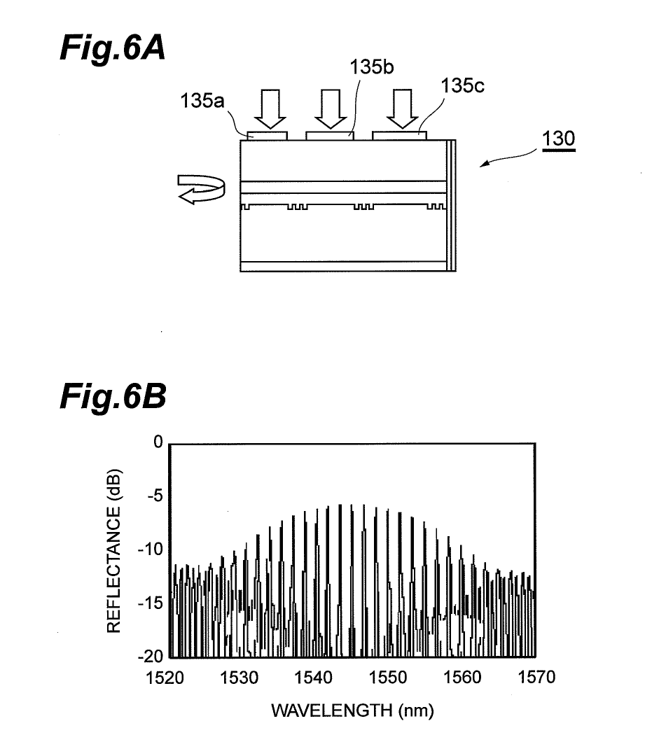

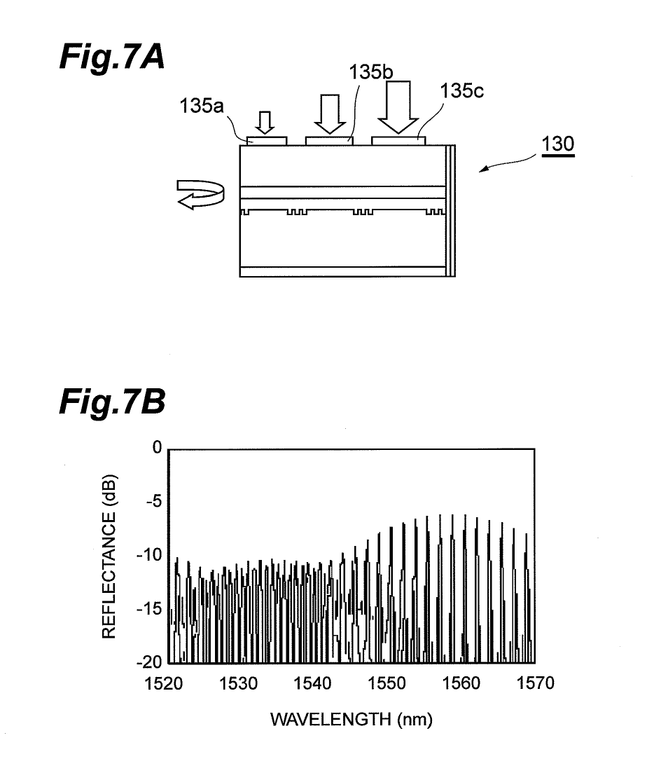

As shown in FIG. 5A, when the temperature distribution is set in the CSG-DBR region 130 such that the temperature of the region closer to the SG-DFB region 120 than the other region is higher than the temperature of the other region, the enveloped reflectance spectrum of the CSG-DBR region 130 may be enhanced in the relatively lower wavelength region, as shown in FIG. 5B. Accordingly, the emission wavelength may converge to the single wavelength existing in the wavelength region with relatively higher reflectance among the wavelengths set by the Vernier effect. In addition, when the temperature distribution is changed as shown in FIG. 6A and FIG. 7A, the enveloped reflectance spectrum of the CSG-DBR region 130 may be enhanced in the relatively higher wavelength region compared to the enveloped reflectance spectrum of FIG. 5B, as shown in FIG. 6B and FIG. 7B. Accordingly, varying the temperature distribution of the CSG-DBR region 130 allows the wavelength set by utilizing the Vernier effect to be tuned. The temperature distribution of the CSG-DBR region 130 may be set by the currents supplied to the heater 136a, 136b and 136c for the regions 130a, 130b, and 130c, respectively.

Further referring to FIG. 3A, the SG-DFB region 120 provides the DFB regions 120a and the tuning regions 120b which are alternatively arranged in the optical guiding direction. Applying a bias voltage or a bias current to the tuning electrodes 125b, the optical guiding layers 122b may change the equivalent refractive index thereof. As shown in the expression (1), the peak interval of the emission spectrum of the SG-DFB region 120 depends on the equivalent refractive index of each of the segment. Adjusting the bias current/voltage applied to the tuning electrodes 125b, the peak wavelengths of the emission spectrum of the SG-DFB region 120 may be changed.

In the laser region 100, the electrodes 115, 125a 135b, 135a, 135b, 135c, and 145 are connected to respective biases independent to others. Supplying the current into the electrodes 125a, the active layers 122a may generate photons. The generated light propagates in the waveguide 122a, 122b, and 132, and is reflected between the SG-DFB region 120 and the CSG-DBR region 130 reiteratively. As a result, the laser region 100 may emit laser light. A portion of the laser light is amplified in the optical amplifying layer 112, is output outward, and then is coupled to the optical modulator region 200. On the other hand, the absorption layer 142 may absorb light leaked through the CSG-DBR region 130. The current injected from the electrode 115 may adjust the optical gain of the amplifying layer 112. Accordingly, it may be possible to keep the power of the optical output from the LD 20 by monitoring a portion of the light output from the optical modulator region and performing auto-power control (i.e. APC).

The aforementioned wavelength controlling mechanism enables the emission wavelength of the laser region 100 to be selected. To match the selected emission wavelength with the WDM grid wavelength defined in ITU-T, the TOSA 14 has a temperature controller described below, and mounts the LD 20 above the temperature controller. In the TOSA 14, the temperatures of the optical guiding layer 132, the active layers 122a, and the optical guiding layers 122b may be adjusted by controlling the temperature controller. Accordingly, the emission wavelength selected by utilizing the Vernier effect and controlling the temperature distribution of the CSG-DBR region 130 may be matched with the WDM grid wavelength.

The laser light whose wavelength is set to the WDM grid wavelength by the aforementioned mechanism is output from the SOA region 110 and then coupled to the optical modulator region 200. On the other hand, the laser light entering in the optical absorbing layer 142 is absorbed in the layer 142. The rear facet of the laser region 100 or the end face of the optical absorbing layer 142 has reflectivity equal to or greater than 10%, and the light reflected by the rear facet is absorbed in the layer 142 again. Accordingly, the LD 20 may suppress stray light due to laser light output from the rear facet. In one embodiment, the optical output from the rear facet may be not more than 1% of the optical output from the front side or the SOA region 110. According to the embodiment, stray light may be suppressed more efficiently.

In addition, when the rear facet has reflectivity equal to or greater than 10%, it may also protect external stray light from entering within the laser region 100 through the rear facet. In one embodiment, the rear facet may have reflectivity equal to or greater than 20%. In addition, the stray light entering the laser region 100 from the rear facet is absorbed in the optical absorbing layer 142. Accordingly, the stray light entering the optical cavity or the SG-DFB region 120 and the CSG-DBR region 130 may be suppressed.

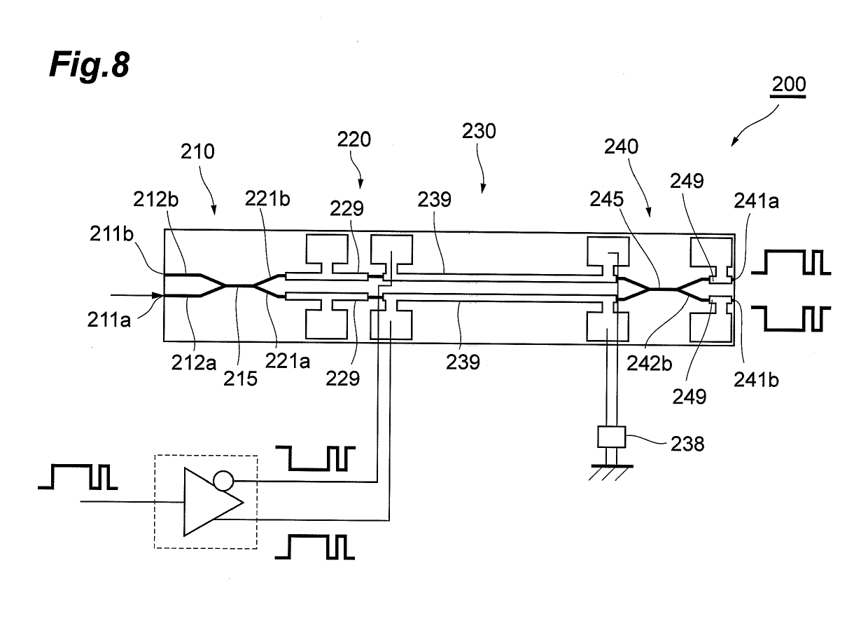

Next, the optical modulator region 200 will be described. FIG. 8 is a plan view schematically illustrating an optical modulator region according to one embodiment. The optical modulator region 200, which is a type of what is called the Mach-Zender modulator, includes a first coupling section (multi mode interference) 210, a phase adjusting section 220, a modulating section 230, and a second coupling section 240.

The first coupling section 210 includes a first input port 211a, a first input waveguide 212a, a second input port 211b, a second input waveguide 212b, and a first coupling waveguide 215. The first input port 211a is optically coupled with the front side of the laser region 100 and receives the output light of the laser region 100. The first input waveguide 212a is connected to the first input port 211a and the second input waveguide 212b is connected to the second input port 211b. The first input waveguide 212a and the second input waveguide 212b join at the first coupling waveguide 215. The first coupling waveguide 215 divides into a first waveguide 221a and a second waveguide 221b. The first waveguide 221a and the second waveguide 221b extend across the phase adjusting section 220 and the modulating section 230. With respect to an axis of the optical modulator region 200 which extends along the longitudinal direction of the optical modulator region 200, a first waveguide 221a and the first input waveguide 212a are arranged in the same side, and a second waveguide 221b and the second input waveguide 212b are arranged in the same side.

The second coupling section 240 includes a second coupling waveguide 245, a first output waveguide 242a, and a second output waveguide 242b. The first waveguide 221a and the second waveguide 221b join at the second coupling waveguide 245. The second coupling waveguide 245 divides into the first output waveguide 242a connected to a first output port 241a and the second output waveguide 242b connected to a second output port 241b. With respect to the axis of the optical modulator region 200 which extends along the longitudinal axis of the optical modulator region 200, the first output port 241a and the second waveguide 221b are arranged with the same side, and the second output port 241b and the first waveguide 221a are arranged with the same side.

The optical path length of the first waveguide 221a is different from that of the second waveguide 221b by a preset condition. In one embodiment, the difference between the optical path length of the first waveguide 221a and that of the second waveguide 221b is set such that light propagating in the waveguide 221a and light propagating in the waveguide 221b shows a phase difference of −π/2.

The first and second waveguides 221a and 221b, each of which is often called as an arm, provide arm electrodes thereon. Each of the arm electrodes may adjust the phase of the light propagating in the arm. In one embodiment, each of the arm electrodes includes a phase adjusting electrode 229 and a modulator electrode 239. The phase adjusting electrode 229 and the modulator electrode 239 are spaced apart from each other. Positional relation between two electrodes, the phase adjustor electrode 229 and the modulator electrode 239, is not restricted to those shown in FIG. 8. In one embodiment, the phase adjustor electrode 229 is arranged in a side close to the input port compared to the modulator electrode 239. Moreover, each of the first and second output waveguides 242a and 242b provides a monitor electrode 244.

One ends of the modulator electrodes 239 are connected to an external driver circuit. The other ends of the modulator electrodes 239 are connected to a termination resistor 238. The external driver circuit applies to the modulator electrodes 239 modulation voltage signals for modulating light propagating in the first waveguides 221a and light propagating in the second waveguide 221b, respectively. Applying the modulation voltage signal to the modulator electrodes 239, the refractive indices of the cores in the first and second waveguides 221a and 221b varies to modulate the phase of the light propagating in the first waveguides 221a and the phase of the light propagating in the second waveguide 221b.

The external driver provides differential signals to the modulator electrode 239 of the first waveguide 221a and the modulator electrode 239 of the second waveguide 221b That is, when the modulator electrode 239 of the first waveguide 221a receives a high drive voltage, the modulator electrode 239 of the second waveguide 221b receives a low drive voltage. Oppositely, when the modulator electrode 239 of the first waveguide 221a receives the low drive voltage; the modulator electrode 239 of the second waveguide 221b receives the high drive voltage. Thus, the difference of voltages between the voltage applied to the modulator electrode 239 of the first waveguide 221a and the voltage applied to the modulator electrode 239 of the second waveguide 221b generates a phase difference between the light propagating in the first waveguide 221a and the light propagating in the second waveguide 221b according to the difference of the voltages.

For instance, when the modulator electrode 239 of the first waveguide 221a receives the high drive voltage, while the modulator electrode 239 of the second waveguide 221b receives the low drive voltage, the light propagating in the first waveguide 221a causes the phase difference by −π/2 compared to the light propagating in the second waveguide 221b. On the other hand, when the low drive voltage is applied to the modulator electrode 239 of the first waveguide 221a, while the high drive voltage is applied to the modulator electrode 239 of the second waveguide 221b, the phase difference by +π/2 is caused between the light propagating in the first waveguide 221a and the light propagating in the first waveguide 221b.

As previously described, the optical path length of two waveguides 221a and 221b has the difference corresponding to the phase shift by −π/2. Accordingly, when the modulation signals applied to the modulator electrodes 239 cause the phase difference of −π/2 between the light propagating in the first waveguide 221a and the light propagating in the second waveguide 221b, the phase difference between the light at the end of the first waveguide 221a and the light at the end of the second waveguide 221b becomes −π. In this case, the light is output from the first output port 241a but vanishes at the second output port 241b.

On the other hand, when the modulating signals cause the phase difference of +π/2 between the light propagating in the first waveguide 221a and the light propagating in the second waveguide 221b, the phase difference between the light at the end of the first waveguide 221a and the light at the end of the second waveguide 221b becomes 0. In this case, the light is output from the second output port 241b and vanishes at the first output port 241a.

Thus, depending on the phase difference between the light propagating in the first waveguide 241a and the light propagating in the second waveguide 241b, the port from which the light input from the first input port 211a is extracted changes between two output ports 241a and 241b. The light output from the first output port 241a, or the light from the second output port 241b may be utilized as a modulated optical signal. In one embodiment, the light output from the first output port 241a is utilized as the modulated optical signal.

In practical manufacturing of the Mach-Zehnder optical modulator, manufacturing variations may occur, the optical path lengths and widths of the waveguides are not always coincident with those designed values. Thus, the optical path lengths of the first and second waveguides 241a and 241b may not be coincident with those designed values, which may cause the phase difference between the light propagating in the first waveguide 241a and the light propagating in the first waveguide 241b to deviate from the designed value. Such an error of the optical phase difference from the designed value may be adjusted with phase adjustment.

Specifically, in the phase adjustment, a DC voltage is applied to each of the phase adjustor electrodes 229 to adjust the phase of the light propagating in the first waveguide 221a and the phase of the light propagating in the second waveguide 221b. That is, the DC voltages applied to the phase adjustor electrodes 229 may be fed back from the intensities of the optical outputs monitored by the monitoring electrodes 249. The output waveguides 242a and 242b arranged beneath the monitoring electrodes 249 may operate as a photodiode of an optical waveguide type. The light propagating in the output waveguide 242a and the light propagating in the output waveguide 242b may be converted to the photocurrents Ipd, respectively, and the intensities of the optical outputs may be detected based on the photocurrents Ipd. When the phase difference between the light propagating in the first output waveguide 241a and the light propagating in the second output waveguide 241b is zero or −π, the intensity of the light output from the first output port 241a and that from the second output port 241b become equal to the others within a constant time period. Accordingly, a phase adjustor circuit adjusts the voltage applied to the phase adjustor electrodes 229 such that the intensity of the light (i.e. the voltage based on the photocurrent) output from the first output port 241a and that from the second output port 241b become equal to each other. Thus, the phase difference between the light propagating in the first waveguide 241a and the light propagating in the second waveguide 241b becomes 0 or −π to correct the deviation of the phases from the designed values.

Next, the TOSA 14 installing the LD 20 therein will be described in detail. The TOSA 14 includes the body 14a with a box shape and a coupling portion 14c. As shown in FIG. 2, the coupling portion 14c couples the body 14a with the sleeve 14b.

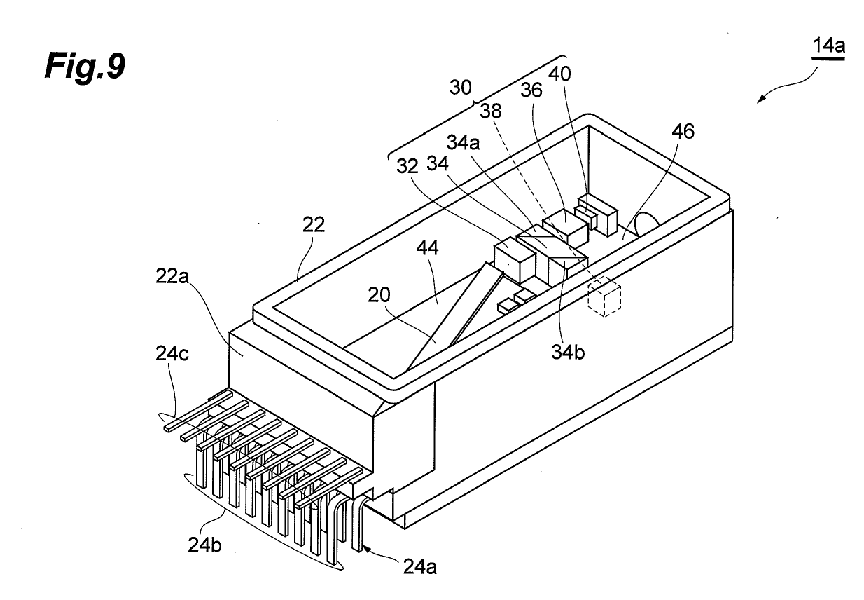

FIG. 9 is a perspective view illustrating an inside of an optical transmitter subassembly according to one embodiment. As shown in FIG. 9, the body 14a includes a case 22. A plurality of lead pins extend from a rear wall of the case 22. The case 22 may be made of metal, but a portion of the case 22 from which the lead pins are extracted may be made of ceramics to secure the electrical isolation between the lead pins and the case 22.

In one embodiment, the lead pins are arranged in three rows, to configure a lead pin groups 24a, 24b, 24c, each of which includes several lead pins. The lead pins of the lead pin group 24c supply signals including high-frequency components. The signals supplied through the lead pins of the lead pin group 24c include, for example, a high frequency signal for driving the optical modulator region 200, currents supplied to the heaters of the CSG-DBR region 130, or a signal directly supplied to the laser region 100. The lead pins 23c are impedance-matched to suppress the degradation of the signal quality of the high frequency signals. The lead pins of the lead pin groups 24a and 24b supply signals including DC component or low-frequency components. The signals supplied through the lead pins of the lead pin groups 24a and 24b include, for example, signals supplied to the laser region 100 other than the heater electrodes, or signals supplied to the optical modulator region 200 other than the modulation signals.

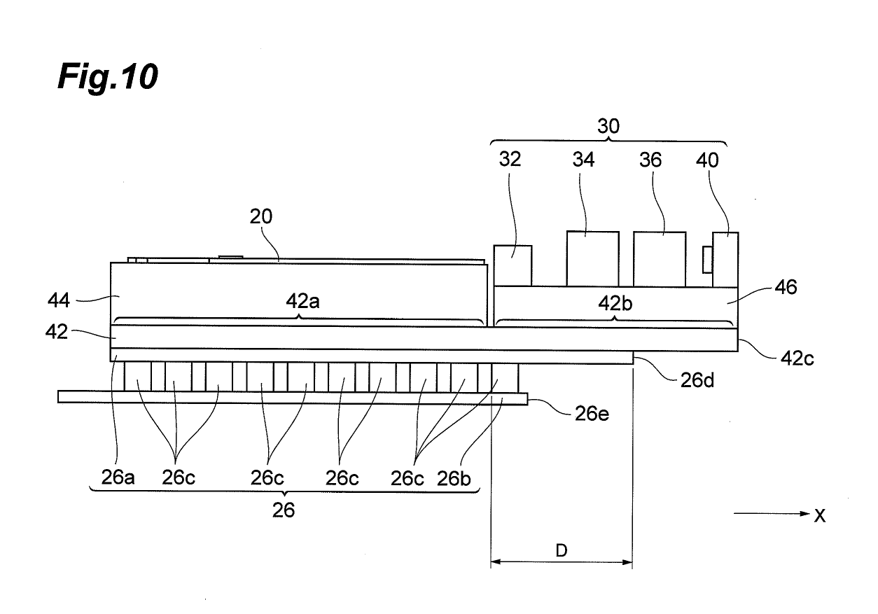

Next, FIG. 10 will be referred to in addition to FIG. 9. FIG. 10 is a side view illustrating an inside of a case of an optical transmitter subassembly according to one embodiment. As shown in FIG. 10, the LD 20 is provided above a temperature controller 26. In one embodiment, the longitudinal direction of the temperature controller 26 is aligned with the longitudinal direction of the case 22, but the longitudinal direction of the LD 20 is inclined with respect to the longitudinal direction of the temperature controller 26. That is, the optical axis of the light output from the LD 20 has a specific angle to the light emitting face of the LD 20 other than a right angle. Accordingly, even when the light emitted from the LD 20 is externally reflected and scattered, and the scattered light returns the LD 20, the scattered light may not return the optical waveguide in the LD 20 and may not cause an optical noise to be generated.

Referring to FIG. 9 and FIG. 10, the TOSA 14 has an optical system 30 for fixing a wavelength of the output light of the LD 20. In one embodiment, the optical system 30 includes a lens 32, an optical branching element 34, an etalon filter 36, a first photodiode 38, and a second photodiode 40.

The light output from the LD 20 is condensed by the lens 32 and then enters the optical branching element 34. The optical branching element 34 includes a first prism 34a (i.e. a first optical coupler) and a second prism 34b (i.e. a second optical coupler). The first prism 34a divides the light entering the optical branching element 34 or the light from the lens 32 to output first light and second light. The ratio of intensity of the first light to intensity of the second light may be arbitrarily, and be, for instance, 50:50. The second light enters the etalon filter 36. The light transmitted through the etalon filter 36 enters the second photodiode 40. The first light enters the second prism 34b. The second prism 34b divides the first light to output third light and fourth light. The third light enters the first photodiode 38. The fourth light travels toward the optical coupling portion 14c.

The first photodiode 38 senses the intensity of the light output from the LD 20, and the second diode 40 senses the light transmitted thorough the etalon filter 36. The etalon filter 36 has the periodic transmittance with respect to the wavelength. In one embodiment, the period of the transmittance roughly corresponds to a span between grids of the WDM optical communication standard. Controlling the temperature of the LD 20 with the temperature controller 26 based on the sensed intensity of the second photodiode 40, the TOSA 14 may control the emission wavelength of the LD 20 so that the emission wavelength is aligned with one of the ITU-T grids. In the TOSA 14, the optical system 30 and the LD 20 are supported by the temperature controller 26. The temperatures of the optical system 30 and the LD 20 are precisely controlled by the temperature controller 26.

As shown in FIG. 10, the TOSA 14 has the temperature controller 26, a base (the first base) 42, a base (the second base) 44, and a base (the third base) 46. The temperature controller 26 includes a first plate (hereinafter referred as “top plate”) 26a, a second plate (hereinafter referred as “bottom plate”) 26b, and a plurality of temperature controlling elements 26c. In one embodiment, the first plate 26a and the second plate 26b may be made of sapphire or AlN. The temperature controlling elements 26c are Peltier elements, and put between the first plate 26a and the second plate 26b. The Peltier elements 26c are electrically connected in series. The first plate 26a of the temperature controller 26 supports the base 42.

The base 42 may be made of CuW. The base 42 includes a first region 42a and a second region 42b. Mounted on the first region 42a is the base 44, and mounted on the second region 42b is the base 46. The bases 44 and 46 may be made of AlN. The base 44 mounts the LD 20 thereon, and the base 46 mounts the optical system 30 thereon.

In the TOSA 14, a portion of the base 42 including the first region 42a is mounted on the top plate 26a. That is, the first region 42a of the base 42 is mounted on the top plate 26a. In addition, a portion of the base 42 other than the first region 42a may be mounted on the top plate 26a. In one embodiment, the top plate 26a may extend beyond a boundary between the first region 42a and the second region 42b and extends to an intermediate portion of the second region 42b in a direction X, which is a direction from the first region 42a toward the second region 42b. In one embodiment, the Peltier elements 26c are provided beneath the first region 42a which mounts the LD 20 thereabove, and a space where no Peltier elements are placed is provided beneath the second region 42b which mounts the optical system 30 thereabove. This is because the temperature of the LD 20 needs to be controlled precisely, but the temperature characteristic of the optical system 300 is relatively insensitive compared to the temperature characteristic of the LD 20.

The cost of the TOSA 14 depends on the number of Peltier elements of the temperature controller 26, and the number of the Peltier elements depends on a plane area of a region where the Peltier elements are placed. In the TOSA 14, the plane area is an area of a plane within a space that is put between the first plate 26a and the second plate 26b, and which is parallel to the first plate 26a. According to the temperature controller 26 of one embodiment, the plane area is small, and the cost reduction of the TOSA 14 may therefore be realized. In addition, the temperature control of the optical system 30 may be performed indirectly with the CuW base 42 having a thickness of, for example, 1.0 mm. Further, extending the top plate 26a to the intermediate portion of second region 42b in the direction X may allow the structure for supporting the optical system 30 to secure a necessary strength.

In one embodiment, the base 42 has an edge 42c that terminates the second region 42b in the direction X. The top and bottom plate 26a and 26b have the edges 26d and 26e which terminate the top and bottom plate 26a and 26b in the direction X, respectively. In one embodiment, a distance between the edge 42c and the edge 26e in the direction X is larger than a distance between the edge 42c and the edge 26d in the direction X. This embodiment further reduces the plane area of the region where the Peltier elements 26c are placed. Accordingly, this embodiment may further reduce the cost of the TOSA 14.

Next, a protruding amount D, that is a length by which the top plate 26a protrude in a side of the second region 42b beyond the boundary between the first region 42a and the second region 42b in the direction X, will be discussed. Table 1 below shows a relationship between the protruding amount D and the resonant frequency of a portion (hereafter referred as “free portion”) of the second region 42b under which the first plate 26a is not provided, obtained by a simulation. In the simulation, the resonant frequency of the free portion was calculated by simulating the case where the base 46 and the optical system 30 are omitted. In Table 1, “D=0” corresponds to the case where the top plate 26a does not protrude in the second region 42b, that is, the case where the temperature controller 26 does not extend under the second region 42b. Here, the plane area of the region where the Peltier elements 26c are placed is 4×8 mm².

TABLE 1

| | Resonant Frequency 1 | Resonant Frequency 2 |
|---|---|---|
| D (mm) | (kHz) | (kHz) |
| 0 | 33 | 83 |
| 1 | 76 | 132 |
| 2 | 152 | 214 |

As shown in Table 1, two resonant frequencies may be generated in the free portion. The resonant frequencies depend on the rigidity and the length of the free portion. Namely, as shown in Table 1, the larger the protruding amount D is, the higher the resonant frequencies are. Accordingly, by adjusting the protruding amount D the vibration amplitude of the free portion may be reduced, and influence in operation of the optical system 30 caused by vibration of the free portion may therefore be suppressed. In addition, when the protruding amount D is 2 mm, the two resonant frequencies exceed 100 kHz. When two resonant frequencies exceed 100 kHz, the vibration amplitude of the free portion becomes about 0.04 μm. Accordingly, the protruding amount D which is not less than 2 mm may further suppress influence in operation of the optical system 30 caused by vibration of the free portion.

In one embodiment, a thickness of the base 44 may be larger than a thickness of the base 46. In other word, the thickness of the base 46 is smaller than the thickness of the base 44. According to the embodiment, reducing the thickness of the base 46 enables the resonant frequency of the base 46 to be raised, which may reduce the vibration amplitude of the base 46 caused by a mechanical shock.

Next, the thickness of the base 42 will be discussed. Table 2 shows the relationship between the thickness t of the CuW base 42, and the resonant frequencies of the free portion of the base 42 and the amount of the physical variation of the free portion caused by applying a mechanical shock to the edge 42c of the base 42, obtained by a simulation.

TABLE 2

| | | | Amount of | Amount of |
|---|---|---|---|---|
| | | | Physical Variation | Physical Variation |
| | Resonant | Resonant | Caused by | Caused by |
| t | Frequency | Frequency | 200 G Shock | 1500 G shock |
| (mm) | 1 (kHz) | 2 (kHz) | (μm) | (μm) |
| 0.44 | 20 | 75 | 0.27 | 2.03 |
| 0.69 | 28 | 73 | 0.05 | 0.38 |

To obtain the result shown in Table 2, the state where the base 46 and the optical system 30 is equipped was simulated, and the protruding amount D was set to 2 mm. As shown in Table 2, when the thickness of the base 42 was 0.69 mm, the amount of the physical variation of the free portion was an amount of submicron level, even in the cases where 200 G mechanical shock was applied and where 1500 G mechanical shock was applied. Accordingly, the base 42 in the TOSA 14 of one embodiment, which has a thickness of 1 mm, may secures a sufficient tolerance to a mechanical shock.

Although the present invention has been fully described in conjunction with the embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An optical transmitter subassembly comprises:
a temperature controller including a first plate, a second plate, and a plurality of temperature controlling elements put between the first and second plates;
a first base having a first region and a second region;
a second base mounted on the first region of the first base;
a third base mounted on the second region of the first base;
a tunable laser diode integrated with a Mach-Zehnder type optical modulator, the tunable laser diode being mounted on the second base; and
an optical system for fixing a wavelength of the laser diode, the optical system being mounted on the third base,
wherein a portion of the first base including the first region is mounted on the first plate.

2. The optical transmitter subassembly according to claim 1, wherein the first plate extends beyond a boundary between the first region and the second region and extends to an intermediate portion of the second region in a direction from the first region toward the second region.

3. The optical transmitter subassembly according to claim 2, wherein the first base has an edge that terminates the second region in the direction,
the first and second plates have edges that terminate the first and second plates in the direction, respectively, and
a distance between the edge of the first base and the edge of the second plate is larger than a distance between the edge of the first base and the edge of the first plate.

4. The optical transmitter subassembly according to claim 1, wherein the optical system includes:
a first coupler that divides light from the laser diode to output at lease first light and second light;
a second coupler that divides the first light to output at least third light and fourth light;
a first photodiode that receives the third light;
an etalon filter that transmits a portion of the second light therethrough, the etalon filter having periodic transmittance with respect to a wavelength; and
a second photodiode that receives light transmitted through the etalon filter.

5. The optical transmitter subassembly according to claim 1, wherein a thickness of the second base is larger than a thickness of the third base.

6. The optical transmitter subassembly according to claim 1, wherein the second and third bases are made of AlN.

7. The optical transmitter subassembly according to claim 1, wherein the first plate is made of sapphire or AlN.

8. The optical transmitter subassembly according to claim 1, wherein the first base is made of CuW.
